(19) United States
(12) Patent Application Publication
(10) Pub. No.: US 2026/0056326 A1
(43) Pub. Date: Feb. 26, 2026

(54) TECHNIQUES FOR MULTI-DEVICE TIME TO FIRST FIX

(71) Applicant: Apple Inc., Cupertino, CA (US)

(72) Inventors: Paril M. Shah, San Jose, CA (US); Chetan Jayanthmurthy, Santa Clara, CA (US); Jasmin Desai, San Jose, CA (US); Kirk Burroughs, Alamo, CA (US); Kumar Gaurav Chhokra, San Mateo, CA (US)

(73) Assignee: Apple Inc., Cupertino, CA (US)

(21) Appl. No.: 18/810,300

(22) Filed: Aug. 20, 2024

(51) Int. Cl. G01S 19/01

(52) U.S. Cl. CPC G01S 19/01

(57) ABSTRACT

Techniques are described for multi-device position determination. An example method can include processing a request for a position of the first device, the first device having a direct data connection with a second device and executing an application that generates the request. The method can further include determining first position information indicating the position of the first device. The method can further include causing the second device to generate second position information indicating a position of the second device. The method can further include processing the second position information received from the second device. The method can further include selecting between using the first position information and the second position information as indicating the position of the first device. The method can further include providing the selected position information to the application.

### BACKGROUND

Global navigation satellite system (GNSS) satellites orbit the earth and broadcast their position in orbit as well as very accurate time. A computer device can compute a GNSS position based on broadcast information received from GNSS satellites. The time taken by a computer device to compute the first location depends on multiple factors.

### BRIEF DESCRIPTION OF THE DRAWINGS

FIG. 1 is an illustration of an example multi-device positioning system, according to one or more embodiments.

FIG. 2 is an illustration of an example multi-device positioning system, according to one or more embodiments.

FIG. 3 is an illustration of relative example signal strengths, according to one or more embodiments.

FIG. 4 is an example flow chart for multi-device position determination according to one or more embodiments.

FIG. 5 is an illustration of an example system for assistance information-based position determination, according to one or more embodiments.

FIG. 6 is an example process for multi-device position determination, according to one or more embodiments.

FIG. 7 is an example process for multi-device position determination, according to one or more embodiments.

FIG. 8 is an example process for multi-device position determination, according to one or more embodiments.

FIG. 9 is an example process for multi-device position determination, according to one or more embodiments.

FIG. 10 illustrates an example of receive components, in accordance with some embodiments.

FIG. 11 illustrates an example of a UE, in accordance with some embodiments.

FIG. 12 illustrates an example of a network node, in accordance with some embodiments.

### DETAILED DESCRIPTION OF THE INVENTION

A computer device (e.g., a first user device) can include hardware and software for determining the current position of the device. In general, the computer device can be connected to one or more satellites to form a computing system (e.g., a global navigation satellite system (GNSS) that can determine the current position of the computer device.

One issue that can occur is that the computer device is experiencing poor RF conditions that affect the computer device's positioning functionality. The poor RF conditions can include being surrounded by tall structures, such as buildings, mountains, and trees that can either block satellite signals or cause reflected signals. In these cases, the computer device may either be unable to detect the satellite signals or detect reflected signals that generate interference. There can also be atmospheric conditions that affect communication with the satellites. For example, periods of high solar activity or changes in the ionosphere can cause atmospheric conditions that are not conducive to good signal quality between the computer device and the satellites. Another cause of poor RF conditions can be interference caused by nearby devices. If the computer device is in a congested area, signals from nearby devices can cause interference for communication with the satellites.

Each of the above situations can cause a determination of position to be slower or less accurate. One particular situation, in which this can be of particular concern is during an emergency situation. For example, if a vehicle has been involved in an accident, it may be vital for the computer device to quickly ascertain the accurate position of the vehicle. If the computer device is experiencing less than optimal RF conditions, determining the position may be slow or inaccurate. In some instances, there may be a second computer device nearby. For example, a user may have a first computer device (e.g., a first smart phone, first tablet, first wearable device, first user equipment (UE), or other appropriate device) and a second computer device (e.g., a second smart phone, second tablet, second wearable device, second UE, or other appropriate device). Furthermore, the first computer device may be experiencing worse RF conditions than the second computer device. Currently GNSS implementations call for the first computer device and the second computer to independently determine a position in response to an application request. Therefore, if the first computer device is experiencing poor RF conditions, the determination of the position can be slow or inaccurate.

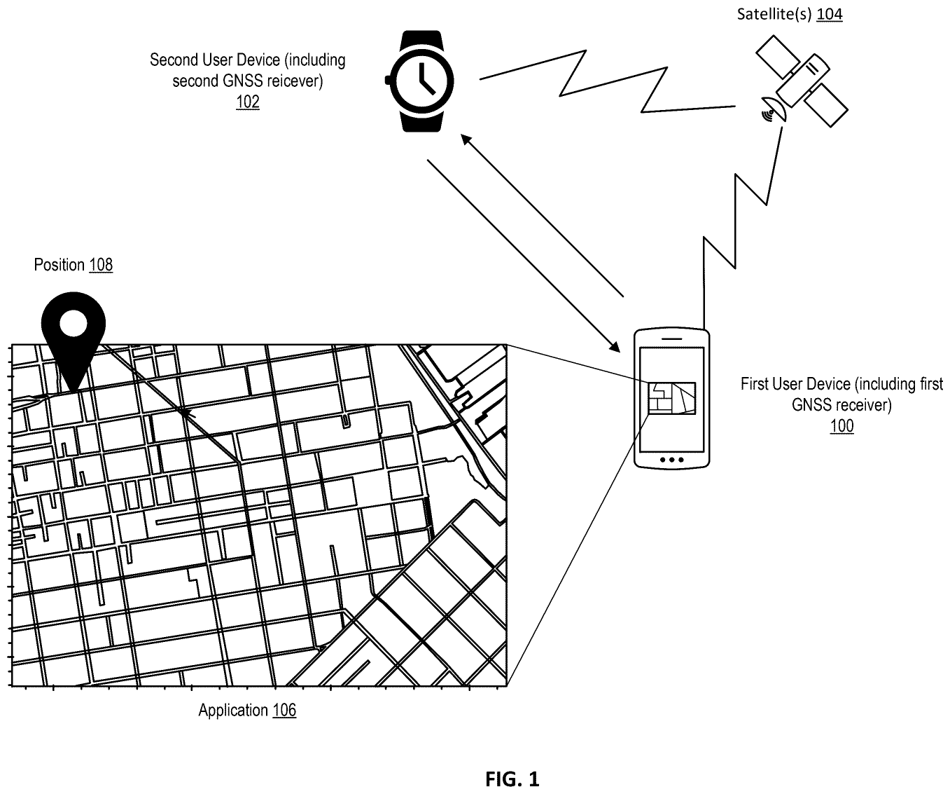

The embodiments herein address the above-referenced issues by describing techniques for using the second computer device to determine a position contemporaneously with the first computer device to improve the speed and accuracy of the positioning determination. The second computer device can share position information (e.g., first fix information that can include a position, a current time, and other appropriate information) with the first computer device, thereby make the position determination faster and more accurate, regardless of the poor RF conditions. The following paragraphs are associated with FIG. 1 and generally describe the position determination process and issues that result from less than optimal RF conditions. The following paragraphs further describe techniques for a second computer device sharing position information with the first computer device to improve the positioning determination of the first computer device.

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A. ”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “connected” may mean that two or more elements, at a common communication protocol layer, have an established signaling relationship with one another over a communication channel, link, interface, or reference point.

FIG. 1 is an illustration of an example multi-device positioning system, according to one or more embodiments. A computer device (e.g., first user device 100 and second user device 102) can be equipped with location-based circuitry for determining the location of the computer device. For example, a computer device can be equipped with a global navigation satellite system (GNSS) circuitry to determine the device's location. Examples of GNSS can include global positioning system (GPS), global navigation satellite system (GLONASS), Galileo, and Beidou.

The first user device 100 can be in communication with a constellation of satellites 104 that are in orbit around the earth. The first user device 100 can further be executing an application 106 that includes features for determining the position 108 of the first user device 100. The first user device can include a first GNSS receiver that includes circuitry for receiving a signal from multiple satellites 104. A first GNSS receiver can include an antenna, a radio frequency (RF) front end, a processor, a memory, and a power supply. The antenna can collect signals from the satellites. The RF front end can include filters and amplifiers for down converting the signals in baseband form to an intermediate form. The processor can be configured to determine the distance between the first user device 100 and the satellites 104. The memory can store software to be used to determine the position of the first user device 100. The power supply can supply the power user to perform the functionality of the first GNSS receiver.

Each of the satellites 104 can continuously broadcast a signal that indicates each satellite's respective position and time of transmission. The first user device 100 via the first GNSS receiver, can process each of the signals received from the satellites 104. The first GNSS receiver can access an internal clock and determine the time delay between each signal being transmitted from a satellite 104 to being received at first user device 100. In some instances, the first GNSS receiver can determine the time delay for signals received from at least four satellites. The first GNSS receiver can then use the time delay and a reference speed for each signal to determine the respective distance between the first user device 100 and each satellite 104.

The first GNSS receiver can then use a technique, (e.g., trilateration, triangulation, or other appropriate technique) to the position of the first user device 100 on earth in a three-dimensional space. For example, the GNSS receiver can determine a longitude, a latitude, and an altitude of the first user device 100. It should be appreciated that the herein described techniques are not limited to GNSS-based position determination, and other position determination techniques can be used. For example, a user device can apply triangulation or trilateration techniques using signals received from different base stations. In another example, a base station can provide a user device a position a determined by a serving cell. Various errors can occur while determining the position of the first user device 100. For example, atmospheric conditions, satellite clock errors, signal reflection, and other conditions can cause the GNSS receiver to experience an error while determining the position of the first user device 100.

The time between the first GNSS receiver collecting enough satellite signals and generating an output (e.g., position information including position, velocity, time (PVT), and other position information) can be referred to a time to first fix (TTFF). There can be various types of TTFFs such as cold starts, warm starts, and hot starts. For a cold start, the first GNSS receiver may have no PVT information or satellite information. In a cold start scenario, the first GNSS receiver may collect information from multiple (e.g., four satellites) satellites 104. The first GNSS receiver may further access almanac information that includes approximate positions of satellites, satellite health information, and orbital parameters. The first GNSS receiver may further access ephemeris information that may include more precise position information and clock correction information than the almanac information as it is updated more frequently.

For example, the first GNSS receiver can perform an initial acquisition of satellite information, in which the receiver can scan for frequencies and codes associated with satellite signals. For each detected signal, the first GNSS receiver can synchronize with the frequency and phase of the satellite signal. The first GNSS receiver can further access the almanac information and the ephemeris information based in the synchronization. The first GNSS receiver can then use the accessed information and the information from the satellite signal to determine position information for the first user device 100.

A warm start scenario can include an instance, in which the first GNSS receiver has some information from a previous session. For example, the first GNSS receiver may have stored one or more of approximate position, approximate velocity, or approximate time information. In a warm start scenario, the first GNSS receiver, however, may not have accessed current ephemeris information. Based on the stored information, the first GNSS receiver may be able to determine which satellites should be visible (e.g., satellites whose signals are not obstructed by structures, such as buildings and trees.) and the geometric distribution of these satellites 104.

These visible satellites 104 may transmit a stronger signal. Based on this information, the first GNSS receiver may be able to engage in an acquisition process more quickly than in a cold start scenario.

As an example, the first GNSS receiver can use stored almanac information to determine which satellites 104 should be visible to the first GNSS receiver. The first GNSS receiver can scan for signals from the satellites 104 that should be visible based on an approximate location and an approximate time. This can include scanning for frequencies that are associated with the satellites 104 that should be visible. As the first GNSS receiver has some information as to which satellites to scan for, in the warm start scenario the first GNSS can complete the acquisition process quicker than the cold start scenario. Once the first GNSS has detected the satellite signals, the first GNSS receiver can synchronize with those signals. The first GNSS receiver can then access the ephemeris information for each of the detected satellites. The first GNSS receiver can then determine the distance between the first user device 100 and each of the satellites 104. Based on this information, the first GNSS receiver can then determine the position of the first user device 100.

A hot start scenario can include an instance, in which the first GNSS receiver has the necessary information from a previous session. For example, the first GNSS receiver can have stored the last known position of the first user device 100, an accurate current time, almanac information, and recent ephemeris information. The acquisition time for a hot start scenario can be faster than for a cold start scenario and a warm start scenario.

As an example of a hot start scenario, after the first GNSS receiver initializes, the first GNSS receiver can access stored almanac information and ephemeris information to identity satellites that should be visible based on the current time and last known position. As the first GNSS receiver has the almanac information and ephemeris information, the satellites 104 can be quickly detected. The first GNSS receiver can then determine the distance between the first user device 100 and each of the detected satellites 104. Based on this information, the first GNSS receiver can then determine the position of the first user device 100.

As described above, whether the first GNSS receiver is engaging in a cold start scenario, a warm start scenario or a hot scenario, the TTFF can be affected. For example, the TTFF can include the shortest time interval for a hot start scenario, and a longest time interval for a cold start scenario. The TTFF time interval associated with the warm start scenario can be between the hot start scenario and the cold start scenario. The embodiments described herein can assist with reducing the time interval for each of these scenarios.

As indicated above, one issue is that if the first user device 100 is experiencing less than optimal radio frequency (RF) conditions, than the speed of determining the position and the accuracy thereof may be diminished. Furthermore, the second user device 102 may situation differently, such that it is experiencing better RF conditions than the first user device 100. For example, after a vehicle accident, the first user device 100 may have gotten situated into a bad position and experience poor RF conditions. However, a user may be wearing a second user device 102 (e.g., a smart watch) which is exposed to the sky and experiencing better RF conditions. Furthermore, the first user device 100 may have an application that sensed the accident and is configured to contact an emergency service (e.g., 911 call) based on the accident. In this situation, it may be critical that the first user device 100 can quickly and accurately determine its position. Therefore, the second user device 102 can assist by determining its own position and transmitting this position information to the first user device 100. The position of the second user device 102 can be different than the position of the first user device 100. The first user device 100 can use the position of the second user device 102 as its own position.

An application 106 executing on the first user device 100 can transmit a request for location information. For example, the application 106 can be an emergency detection application that receives sensors data (e.g., accelerometer information, gyroscope information) that indicates that the first user device 100 is involved in an incident and that emergency services are to be contacted with position information. The first user device 100 can determine it has a connection to the second user device 102. For example, the first user device 100 can be paired with the second user device 102 via a connection. In some instances, the first user device 100 and the second user device 102 are connected to the same network or communicate via a communication protocol (e.g., Bluetooth classic, Bluetooth low energy (BLE), near field communication (NFC), ultra-wideband (UWB), Wi-Fi, or other communication protocol).

The first user device 100 can transmit a message to the second user device 102 to request that the second user device 102 determine its position, which is different than the position of the first user device 100. However, as the first user device 100 and the second user device are co-located at the same geographic location, the position of the second user device 102 can be inferred onto the first user device 100. Co-located devices can be devices that are in physical proximity to each other. For example, co-located devices can be devices that are within a threshold distance of each other (e.g., within ten feet of each other). Co-located devices can also be devices that are within a distance to be able to communicate over a short range communication protocol (e.g., Bluetooth classic, Bluetooth low energy (BLE), near field communication (NFC), ultra-wideband (UWB), Wi-Fi, or other short range communication protocol). In some instances, co-located devices can be devices that can communicate over a wireless communication protocol, in which the signal strength for the communication between one device and the other device is above a threshold signal strength.

In some instances, both the first user device 100 and the second user device 102 can be associated with the same user account and the same user. Referring back to the accident example, both the first user device 100 and the second user device 102 can be situated around the user's car. The message can include, for example, a triggering signal (e.g., a single bit) for the second user device 102 to determine it's position.

Similar to the first user device 100, the second user device 102 can include a second GNSS receiver. As described with respect to the first GNSS receiver above, the second GNSS receiver can determine the position of the second user device 102. As the second GNSS receiver is experiencing better RF conditions than the first GNSS receiver of the first user device 100, the second GNSS receiver determine the positions more quickly or more accurately than the first GNSS receiver. Upon determining its position, the second user device 102 can transmit position information to the first user device 100. Upon receiving the position information from the second user device 102, the application 106 can contact the emergency services and provide the position information.

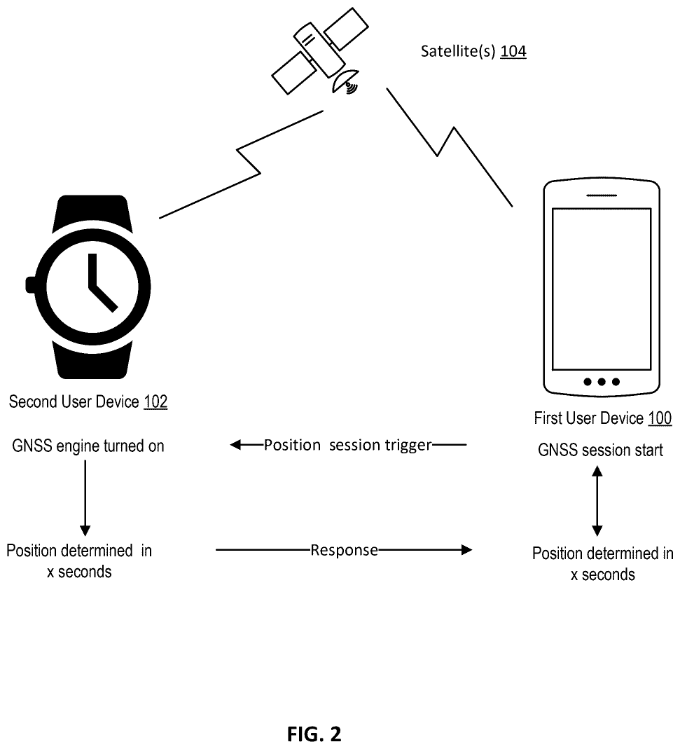

FIG. 2 is an illustration of an example multi-device positioning system, according to one or more embodiments. As illustrated, a first user device 100 can scan for satellite signals to determine its position. For example, an application (e.g., application 106) that is executing on the first user device 100 can request a current position. The first user device 100 can include a first GNSS receiver that can scan for satellite information. However, in some instances, the first user device 100 can be experiencing poor RF conditions, and therefore there may be issues with speed and accuracy of the position determination. Therefore, the first user device 100 can begin to scan in a cold start, warm start, or hot start scenario, to acquire a signal from one or more satellites 104.

The first user device 100 can be co-located with a second user device 102. Furthermore, the second user device 102 may be experiencing better RF conditions than the first user device 100. In response to receiving the request from the application, the first GNSS receiver can start a GNSS session. In addition, the first GNSS receiver can transmit a position session trigger to the second user device 102. For example, the first GNSS receiver can transmit the trigger via a transmission protocol (e.g., Bluetooth, Wi-Fi, or cellular). In some instances, the second GNSS receiver can transmit the position information via a direct data connection on an indirect data connection to the first GNSS receiver. However, in some instances, the second GNSS receiver can be configured to transmit the position information via another device. For example, in some instances, the second GNSS receiver can transmit the position information to a server, and the server can transmit the position information to the first GNSS receiver. In other instances, the second GNSS receiver can transmit the information to a relay device (e.g., a smart phone, a tablet, a wearable device, a vehicle computing system), and the relay device can transmit the position information to the second GNSS receiver.

In response to processing the trigger, the second user device 102 can turn a GNSS engine on via a second GNSS receiver and scan for signals from one or more satellites 104. The second GNSS receiver can engage in the process of acquiring a signal and determine a position in parallel to the first GNSS receiver. However, as the second GNSS receiver is experiencing better RF conditions, the position of the second user device 102 can be determined faster than the first GNSS receiver determines the position of the first user device 100. As illustrated, the second GNSS receiver can determine the position in x seconds. Upon determining the position, the second GNSS receiver can transmit a response to the first GNSS receiver that includes position information that has been determined in x seconds. The first GNSS receiver can then provide the position information to the application. It should be appreciated that the position of the second user device 102, although different, can be inferred as the position of the first user device 100 as they are co-located in the same geographical location.

As illustrated, it can be assumed that the first GNSS receiver can take longer than x seconds to determine the position of the first user device 102. However, in some instances, the first GNSS receiver may determine the position of the first user device 100 faster than the second GNSS receiver transmits the position of the second user device 102 to the first user device 100. In these instances, the first GNSS receiver can provide the determined position of the first user device 100, as determined by the first GNSS receiver, to the application 106.

In yet other instances, the first GNSS receiver may determine the position of the first user device 100 within a short time period of receiving the position information from the second GNSS receiver. In these instances, the first GNSS receiver may determine whether to use the position information from the second GNSS receiver or the position information determined by itself. For example, after receiving the position information from the second GNSS receiver, the first GNSS receiver can determine the position of the first user device 100.

In these instances, the first GNSS receiver can use various considerations to determine whether to use the position information from the second GNSS receiver or from the first GNSS receiver. For example, the second GNSS receiver can transmit context information along with the position information. The context information can include signal strength information for the signals used by the second GNSS receiver to determine the position information. The first GNSS receiver can compare the signal strengths of the signals used by the second GNSS receiver with the signal strengths of the signals used by the first GNSS receiver. The first GNSS receiver can then determine which position information to use based on the comparison. For example, the first GNSS receiver can use the position information that is determined by the highest average signal strengths.

In other instances, the first GNSS receiver can determine whether it determined the position information of the first user device 100 within a threshold time interval of receiving the position information from the second GNSS receiver. For example, if the first GNSS receiver determined the position information before the threshold time interval expired, the first GNSS receiver can transmit the position information that it determined to the application. If, however, the first GNSS receiver determined the position information after the threshold time interval, the first GNSS receiver can transmit the position information determined by second GNSS receiver to the application. In this instance, the first GNSS receiver does not transmit the position information that it determined to the application 106.

In other instances, the first GNSS receiver can be configured to always transmit the position information determined by the second GNSS receiver. In these instances, if the first GNSS receiver determined the position information before the threshold time interval expired, the first GNSS receiver does not transmit the position information to the application. If, however, the first GNSS receiver determined the position information after the threshold time interval, the first GNSS receiver can transmit the position information it determined as updated position information to the application.

As indicated above, the strength of the satellite signals can affect the performance of the first user device 100 and the second user device 102. The signal strength can affect each device's ability to measure a time delay of the satellite signals which is used to determine the distance between the device and the satellite 104. For example, a signal to noise ratio (SNR) can be a measure of the signal's strength in relation to noise. The higher the SNR, the stronger the signal from the satellites 104. Therefore, the higher the SNR, the more accurate the measurements can be of the time delay between the satellite emitting the signal and the device receiving the signal.

Another issue for signal processing by the first user device 100 and the second user device 102 can be multipath effects. A multipath can occur when a signal from a satellite reflects from the surface of nearby objects, such as buildings, vehicles, the ground, or other surface. This causes multiple signal paths and weakens the signal strength. The stronger the signal from the satellite, the easier it is for a device to determine whether the signal is a direct signal from a satellite or a reflected signal, which can reduce interference caused by multipath effects. Another issue that can attenuate a signal, can be matter that the satellite signal has to penetrate to reach a device antenna. For example, a device is stored inside of a briefcase may not receive as strong a signal from a satellite as a device that is laying exposed to the sky.

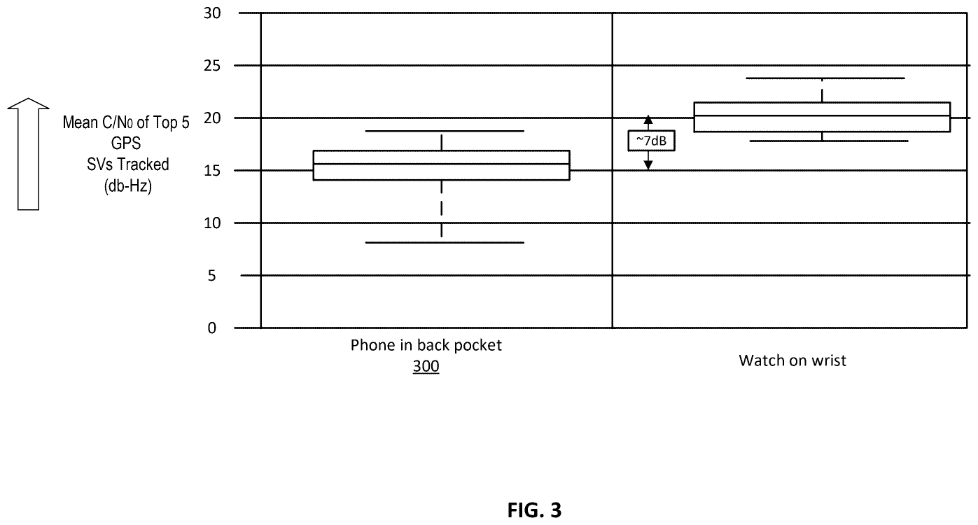

FIG. 3 is an illustration of relative example signal strengths, according to one or more embodiments. In particular, FIG. 3 includes boxplots of signal strengths for two co-located devices. A first user device can be a phone in a back pocket 300 and the second user device can be a watch of a wrist 302. As illustrated, the signal strength of a satellite signal received by the phone in the back pocket 300 on average is around 15 decibel hertz (db-Hz), whereas the signal strength of a satellite signal received by a watch on a wrist 302 is 22 db-Hz. As indicated above, there are various factors that can contribute to two co-located devices measuring different signal strengths. In the example illustrated in FIG. 3, the cause may be that the satellite signal may need to pass through a user or clothing before reaching a phone antenna. On the other hand, the watch is on a wrist and can be directly exposed to the sky to receive signals from different satellites.

This discrepancy in signal strengths can cause the watch to be able to determine its position faster than the phone can determine its position. Therefore, if an application executing on the phone requests a position, the phone can message the watch to trigger a position determining operation. The watch can take advantage of the higher signal strength and determine its position faster and more accurately than the phone can determine its own position. The watch can then transmit the position information (e.g., position of the watch) to the phone. The phone can process the position information and infer the watch's position as its own as both devices are co-located. The phone can transmit the position information to the application as its own position.

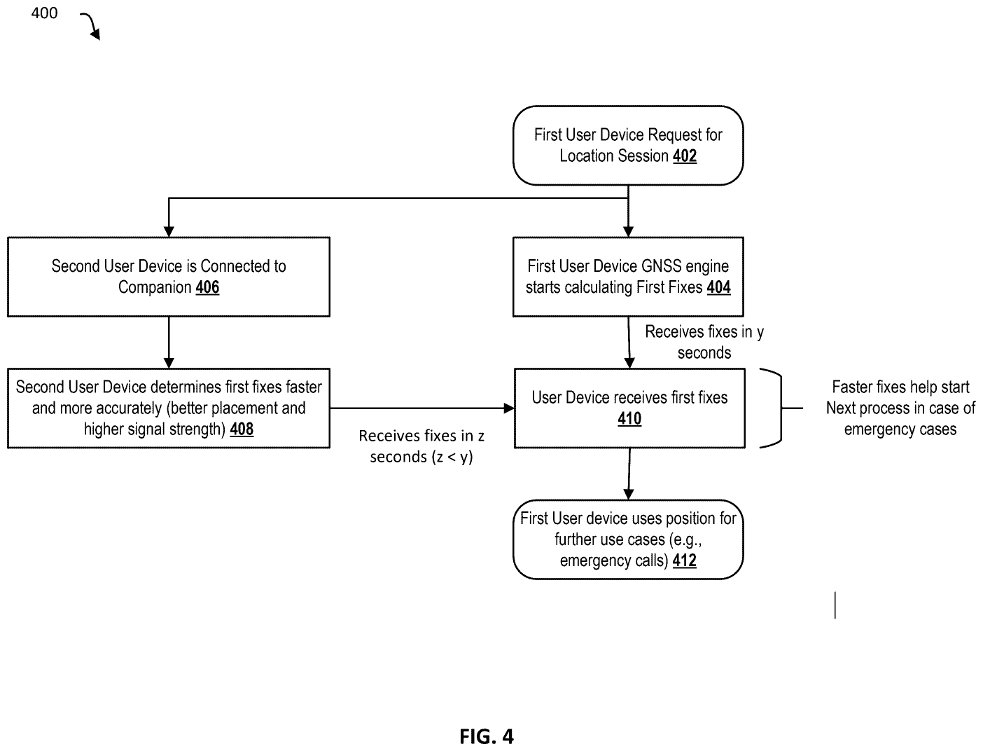

FIG. 4 is an example flow chart 400 for multi-device position determination according to one or more embodiments. At 402, a first user device (e.g., first user device 100) can receive a request for position information. For example, an application executing on the first user device an include a positioning feature and transmit the request to the first user device for its position.

The first user device can include a first GNSS receiver that can initialize the acquisition process for satellite signals at 404. For example, the first user device can scan for satellite signals to detect a requisite number of signals (e.g., four signals) for determining its position. As the first user device may be experiencing poor RF conditions, the acquisition process may take longer than if the first user device was experiencing good RF conditions.

At 406, the first user device can determine that it is connected to a second user device (e.g., second user device 102). For example, the first user device can have stored in memory each connected user device. The first user device can access the memory to determine if any other devices are connected to the first user device. In some embodiments, the first user device can determine whether any other connected device is associated with a same account as the first user device. For example, the first user device can determine whether the first user device is associated with the same user account as the second user device. The first user device can transmit a message to second user device to trigger a position determining process by the second user device. In some embodiments, the first user device transmits the message based on whether the first user device and the second user device are associated with the same account. For example, if the first user device and the second user device are associated with the same account, then the first user device transmits the message to trigger the position determination process. If, however, the first user device and the second user device are not associated with the same account, the first user device does not transmit the message. In some embodiments, the first user device transmits the message based on whether the first user device and the second user device are associated with the same manufacturer. For example, if the first user device and the second user device are associated with the same device manufacturer, then the first user device transmits the message to trigger the position determination process. If, however, the first user device and the second user device are not associated with different manufacturers, the first user device does not transmit the message.

At 408, the second user device can determine its position as described above. As the second user device is experiencing better RF conditions, the second user device's determination can be faster than the first user device's determination. The second user device can transmit the position information to the first user device. At 410, the first user device can receive the position information from the second user device faster than the first user device can determine its own position. For example, the first user device can receive the position information from the second user device in z seconds. Furthermore, the first user device can determine its position in x seconds, where z is less than x.

At 410, the first user device can use the position information from the second user device for further use cases. For example, the first user device can transmit the position information from the second user device to the application. In some instances, the first user device may update the position information from the second user device to indicate that the position is the first user device's position. As it may be unclear to the second user device as to the purpose of the position information, the second user device may transmit position information that indicates as itself as the device. Furthermore, the application may be expecting position information of the first user device. Therefore, the first user device can either generate a new message that indicates the position coordinates and the first user device as the device whose coordinates are being presented. Alternatively, the first user device can update the message from the second user device to replace the second user device's identification information with the first user device's identification information. In other embodiments, the second user device can update the position information from the second user device to indicate that the position is the first user device's position.

As indicated above, position determination can be in a cold start scenario, warm start scenario, and hot start scenario. In a conventional system, whether the first user device has information to initiate a warm start or a hot start is based on the information that the first user device has stored based on its own position determining operations. However, as described herein, the second user device can provide assistance information to enable the first user device to initiate a warm start or a hot start.

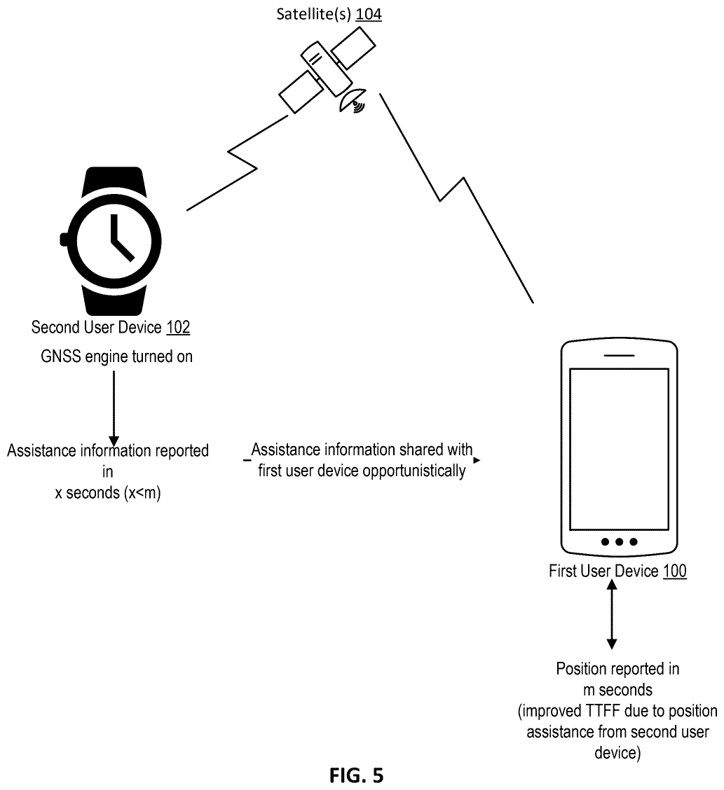

FIG. 5 is an illustration of an example system for assistance information-based position determination, according to one or more embodiments. As illustrated, a first user device 100 is co-located with a second user device 102. Furthermore, the second user device 102 can be experiencing better RF conditions than the first user device 10, such that the second user device 102 can determine its position faster than the first user device 100 can determine its position. In some instances, the second user device 102 can be independently engaging in a position determining process from the first user device 100. For example, an application executing on the second user device 102 can request a position. The second user device 102 can use a process as described above, to determine its position. As illustrated, the second user device 102 can determine its position in x seconds.

The second user device 102 can further determine that it is connected with the first user device 100. Furthermore, the second user device 102 can opportunistically transmit the position information to the first user device 100. In some instances, second user device 102 can transmit the position information to the first user device 100 without a prior request for the position information or a trigger for initiating a position determination process. For example, the second user device 102 may be periodically broadcasting messages that are received by the first user device 100. The second user device 102 can append the broadcast message to include the position information. In another example, the second user device 102 and the first user device 100 can be engaged in communications with each other and the second user device 102 can include the position information in a message to the first user device 100. The position information can be formatted as assistance information and include, for example, a position of the second user device 102, a current time, almanac information, ephemeris information, time delay information and other appropriate information.

The first user device 100 can use the position information as assistance information to accelerate the position determining process. For example, in the instance that an application (e.g., application 106) executing on the first user device 100 requests a position, the first user device 100 can initiate a position determining process. The first user device 100 can access memory to determine if it has any assistance information that it can use to accelerate the process. For example, the first user device 100 can access memory to determine if it has position information, such as approximate position information, last known position information. The first user device 100 can further determine whether it has time information, such as approximate time information, or last known time information. The first user device 100 can also determine whether it has stored almanac information or ephemeris information.

In some instances, the first user device 100 does not have any of the above information stored in memory, and receives the assistance information from the second user device 102. In some instances, the first user device 100 may have previously stored some or all of the above described information and in addition receives the second assistance information from the second user device. In the first scenario, in which the first user device 100 has not have any of the information stored, the first user device 100 can use the assistance information to accelerate the position determining process. In some instances, the first user device 100 can determine whether to use the assistance information. For example, the first user device 100 can use a time interval that has passed between receiving the assistance information from the second user device 102 and initiating its own posting determination process. As the second user device 102 opportunistically provides the assistance information, there may be no correspondence between when the assistance information is received by the first user device 100 and when the first user device 100 initiates a position determination process. Therefore, the first user device 100 can compare the time interval between receiving the assistance information and initiating the position determination process to a threshold time interval. If the time interval exceeds the threshold time interval, then the first user device 100 may determine to not use the assistance information. If, however, the time interval does not exceed the threshold time interval the first user device 100 can use the assistance information from the second user device 102.

In instances, in which the first user device 100 has stored position information and receives the assistance information from the second user device 102, it can determine which information to use. For example, the first user device can determine a time at which the first user device stored the position information and a time (e.g., first time point) at which the assistance information was received (e.g., second time point). The first user device 100 can further use the later of the stored position information and the assistance information based on the times.

In the event that the first user device 100 determines to use the assistance information from the second user device 102, the scenario type can be based on the contents of the position information. For example, if the position information includes an approximate location of the second user device 102, an approximate time, and almanac information, the first user device 100 can engage the positioning determining process in a warm start scenario. The first user device 100 can use the position information to determine satellites 104 that should be visible. Based on the contents of the position information, this can be part of a warm start scenario or a hot start scenario. For example, the first user device 102 can determine whether the assistance information includes ephemeris information. If the assistance information does not include ephemeris information, then the first user device 100 can engage in a warm start using position, time, and almanac information included in the assistance information. If the assistance information includes ephemeris information, then the first user device 100 can engage in a hot start using position, time, and almanac information included in the assistance information.

Therefore, the assistance information enables the first user device to accelerate the position determination process. For example, using the assistance information, the first user device 100 can either forgo a cold start and engage in a warm start or forego a warm start and engage in a hot start.

The second user device 102 can have reported the assistance information in x seconds. The first device 100 can determine the position of the first user device using the assistance information. The first user device 100 can further report the position information to an application (e.g., application 106) in m seconds. Without the assistance information, the first user device 100 may not have been able to report the position information to the application until n seconds, in which m seconds are less than n seconds.

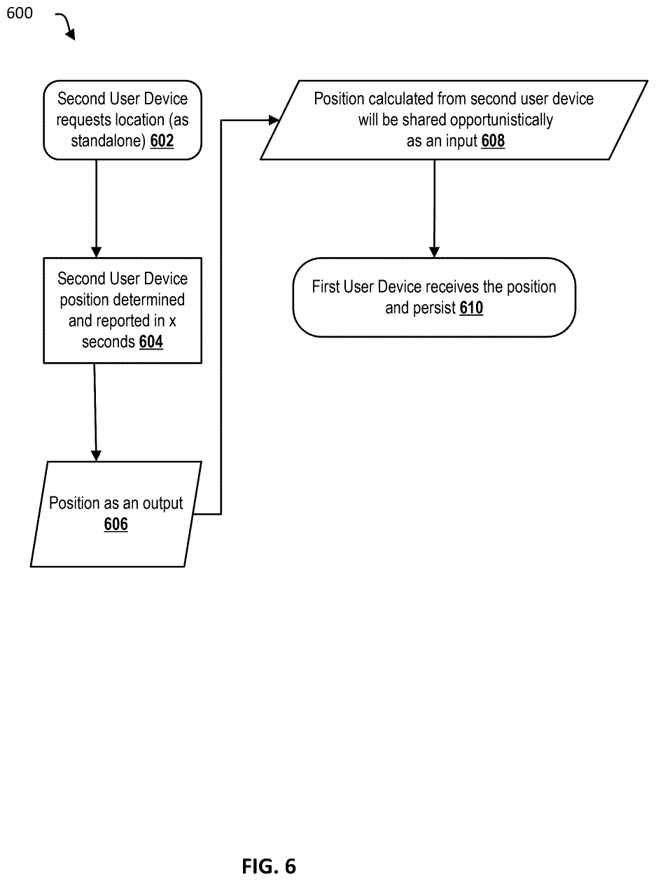

FIG. 6 is an example process flow 600 for multi-device position determination, according to one or more embodiments. At 602, a second user device (e.g., second user device 102) can initiate a position determination process. For example, the second user device can include second GNSS receiver that is configured to determine a position of the second user device. The process for determining the position of the second user device can be as described above.

At 604, the second user device can determine its position and report the position in x seconds. For example, in the instance that an application executing on the second user device requested the position information, the second user device can provide said information to the application.

At 606, the second user device can generate a message that includes assistance information for a first user device (e.g., first user device 100). The assistance information can include one or more of the following, a position of the second user device, a current time, almanac information, ephemeris information, and other appropriate information.

At 610, the first user device can receive the position information. For example, the first user device can receive the position information from a first GNSS receiver. The first user device may or may not have used the assistance information to determine its position. The position information can be stored in memory for accelerating a subsequent position determination process. The first user device can then provide the position information to an application (e.g., application 106).

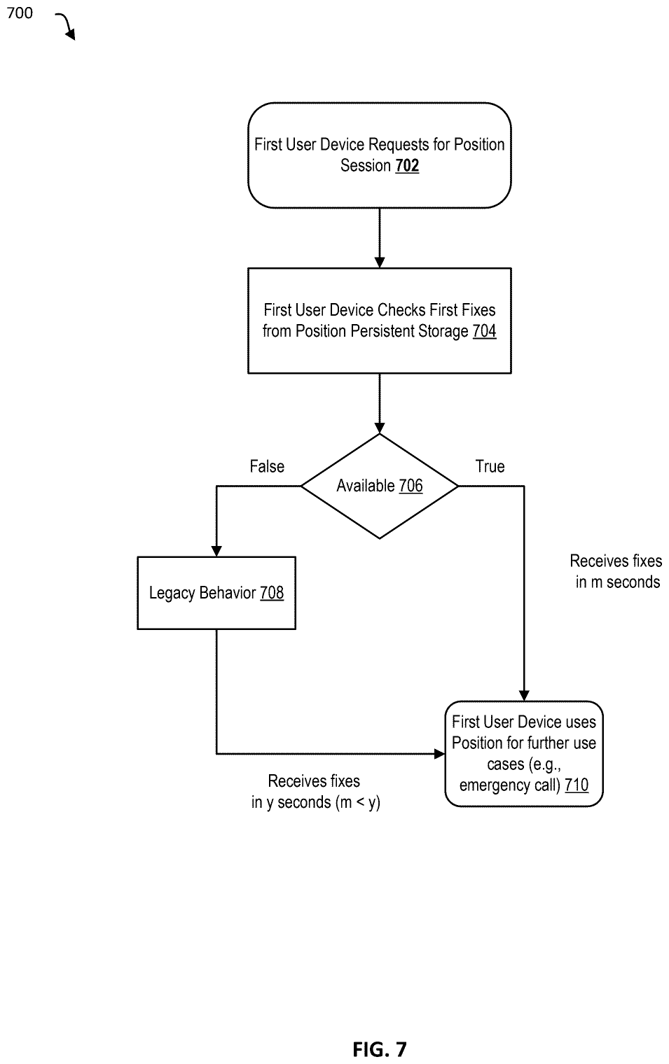

FIG. 7 is an example process flow 700 for multi-device position determination, according to one or more embodiments. At 702, a first user device (e.g., first user device 100) can receive a request for a position session for determining position information. For example, an application (e.g., application 106) can be executing on the first user device and request a current position.

At 704, the first user device can access its memory to determine whether there is any information to be used for the position determining process. For example, the first user device can search for assistance information from a second user device (e.g., second user device 102) or position information that a first GNSS receiver of the first user device has determined. At 706, the first user device can determine whether any such information has been stored in memory. If no information that can be used to assist in the position determining process has been stored, the process 700 can proceed to 708. At 708, the first user device can engage legacy behavior to determine the position information. The legacy behavior can include scanning for satellite signals. Once detected, the legacy behavior can inlcude using the satellite signals to determine a distance between the first user device and each satellite. The legacy behavior can further include determining a position of the first user device based on the distances. The first user device can determine the position information in y seconds.

If, however, information is available at 706, the process 700 can proceed to 710. At 710, the first user device can use the information to engage in the position determination process at a warm start or a hot start as described above. The information can enable the first user device, and in particular the first GNSS receiver, to accelerate the satellite signal acquisition process and thereby accelerate the position determination process. The first user device can determine the position in m seconds, m is less than y. Therefore, it can be seen by using information, such as assistance information from the second user device, the first user device can determine a position faster and more accurately than without the assistance information.

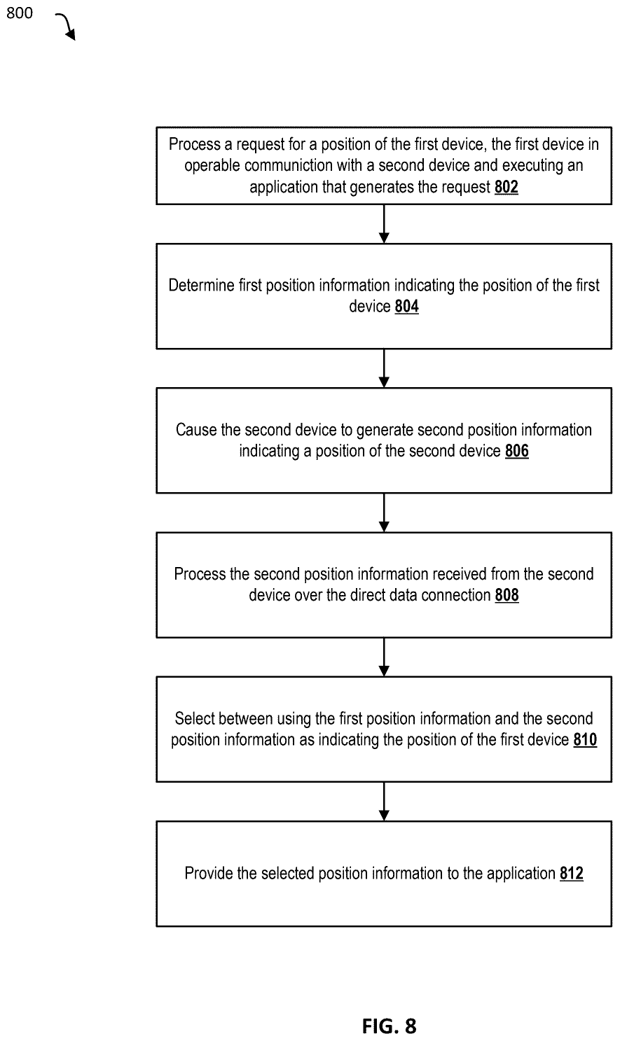

FIG. 8 is an example process 800 for multi-device position determination, according to one or more embodiments. At 802, the process 800 can include a first device (e.g., first user device 100) processing a request for a position of the first device. The first device can have a direct data connection (e.g., Bluetooth classic, Bluetooth low energy (BLE), near field communication (NFC), ultra-wideband (UWB), Wi-Fi, or other communication protocol) with a second device (e.g., second user device 102) and executing an application (e.g., application 106) that generates the request. The first device can also have an indirect data connection (e.g., via server or other computing device) with the second device.

At 804, the process 800 can include the first device determining first position information indicating the position of the first device. The position determination process can include identifying satellite signals and synchronizing with each signal. The position determination process can further include determining a distance between the first computer device and each satellite. The position determination process can further include determining a position of the first computer device based on the distances.

At 806, the process 800 can include the first device causing the second device to generate second position information indicating a position of the second device. A message can trigger a position determination process to occur on the second device in parallel with the first user device's position determination process. The position determination process can be for determining second position information indicating a position of the second device. The position of the first device can be different than the position of the second device.

At 808, the process 800 can include the first device the second position information received from the second device via a direct data connection or an indirect data connection (e.g., via a server or other computing device). As indicated above, the second device can determine its position faster than the first device can determine its position based on the RF conditions that each is experiencing.

At 810, the process 800 can include the first device selecting between using the first position information and the second position information as indicating the position of the first device. The first device can use various parameters (e.g., time, signal strength) to determine whether to use the second position information.

At 812, the process 800 can include the first device providing the selected position information to the application. Regardless of whether the first device uses the second position information or not, the first device can provide position information to the application.

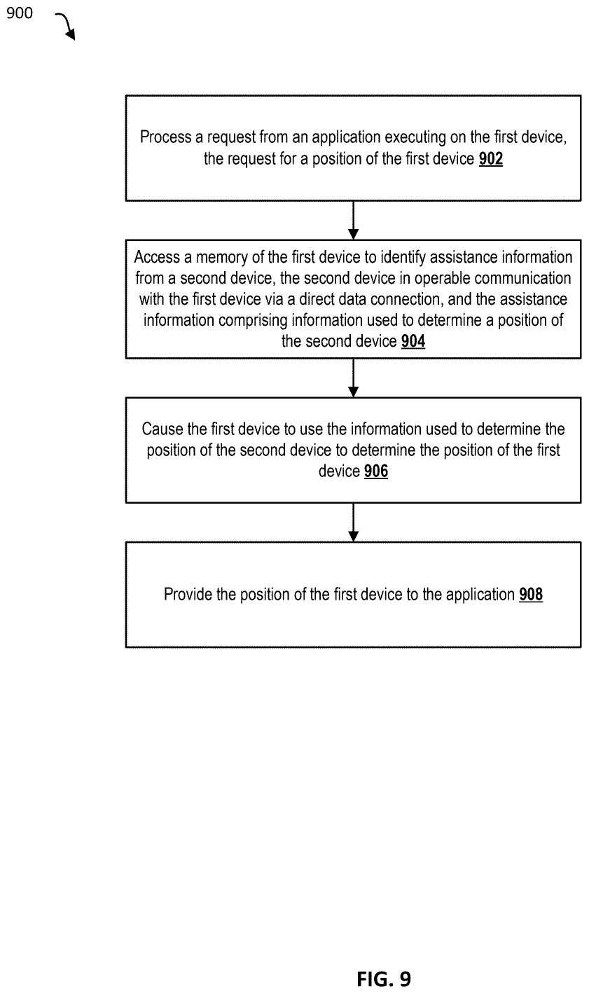

FIG. 9 is an example process 900 for multi-device position determination, according to one or more embodiments. At 902, the process 900 can include a first device (e.g., first user device 100) processing a request from an application (e.g., application 1060 executing on the first device, the request for a position (e.g., position 108) of the first device.

At 904, the process 900 can include the first device accessing a memory of the first device to identify assistance information from a second device (e.g., second device 102), the second device connected to the first device via a direct data connection or an indirect data connection (e.g., via a server or other computing device), and the assistance information comprising information used to determine a position of the second device. The assistance information can indicate a position of the second device. The position of the first device can be different than the position of the second device.

At 906, the process 900 can include the first device causing the first device to use the information used to determine the position of the second device to determine the position of the first device. The first computer device can use various parameters (e.g., time) to determine whether to use the assistance information.

At 908, the process 900 can include the first device providing the position of the first device to the application. The first device can leverage the assistance information to accelerate the position determining process. For example, the assistance information can be used to identify positions of satellites, which speeds up the signal acquisition process.

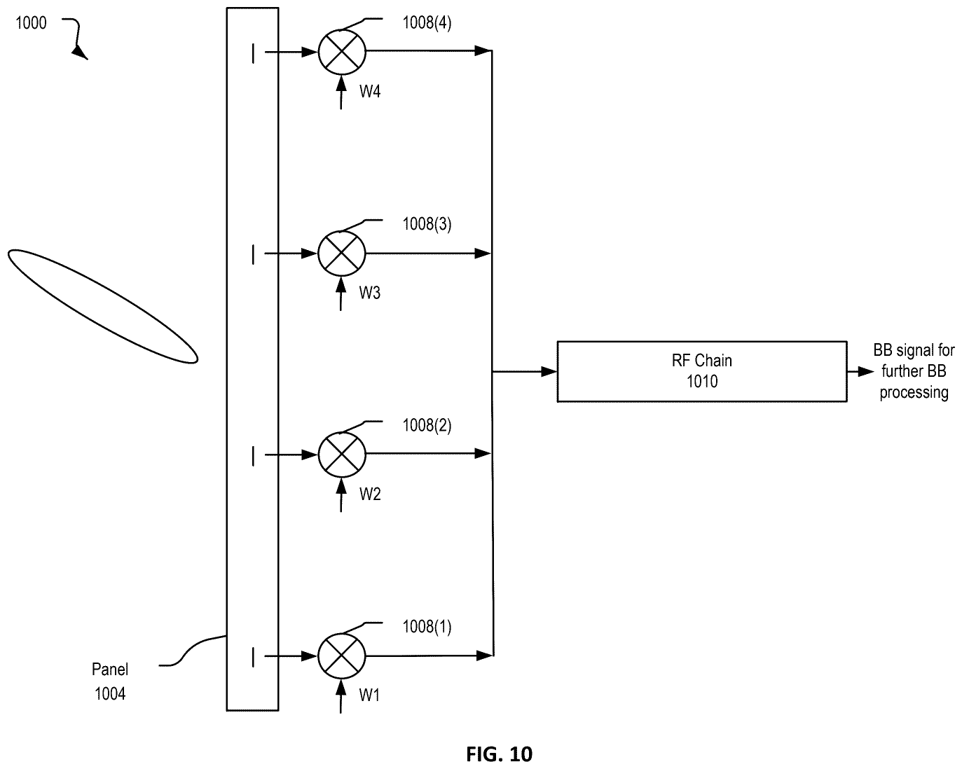

FIG. 10 illustrates receive components 1000 of the first user device 100 (or the second user device 102), in accordance with some embodiments. The receive components 1000 may include an antenna panel 1004 that includes a number of antenna elements. The panel 1004 is shown with four antenna elements, but other embodiments may include other numbers.

The antenna panel 1004 may be coupled to analog beamforming (BF) components that include a number of phase shifters 1008(1)-1008(4). The phase shifters 1008(1)-1008(4) may be coupled with a radio-frequency (RF) chain 1013. The RF chain 1013 may amplify a receive analog RF signal, down convert the RF signal to baseband, and convert the analog baseband signal to a digital baseband signal that may be provided to a baseband processor for further processing.

In various embodiments, control circuitry, which may reside in a baseband processor, may provide BF weights (e.g., W1- W4), which may represent phase shift values, to the phase shifters 1008(1)-1008(4) to provide a receive beam at the antenna panel 1004. These BF weights may be determined based on the channel-based beamforming.

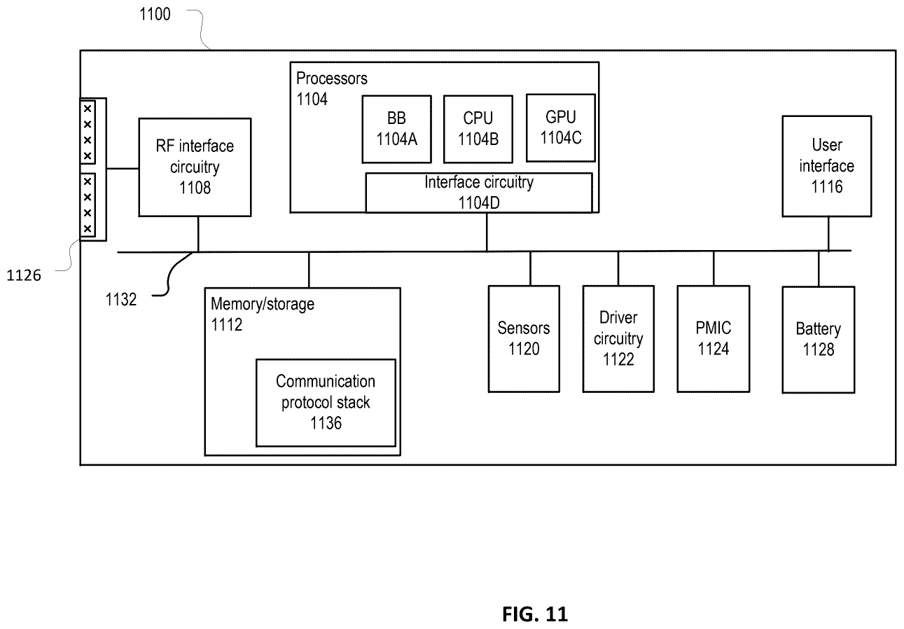

FIG. 11 illustrates a user device 1100, in accordance with some embodiments. The user device 1100 may be similar to and substantially interchangeable with the user device 100 of FIG. 1 or the second user device 102 of FIG. 1.

Similar to that described above with respect to user device 100, the user device 1100 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the user device may be a reduced capacity user device or NR-Light user device.

The user device 1100 may include processors 1104, RF interface circuitry 1108, memory/storage 1113, user interface 1116, sensors 1120, driver circuitry 1122, power management integrated circuit (PMIC) 1124, and battery 1128. The components of the user device 1100 may be implemented as integrated circuits (ICs), portions thereof, discrete electronic devices, or other modules, logic, hardware, software, firmware, or a combination thereof. The block diagram of FIG. 11 is intended to show a high-level view of some of the components of the user device 1100. However, some of the components shown may be omitted, additional components may be present, and different arrangements of the components shown may occur in other implementations.

The components of the user device 1100 may be coupled with various other components over one or more interconnects 1132, which may represent any type of interface, input/output, bus (local, system, or expansion), transmission line, trace, optical connection, etc. that allows various circuit components (on common or different chips or chipsets) to interact with one another.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage 1113 to cause the user device 1100 to perform operations as described herein (e.g., position determination).

In some embodiments, the baseband processor circuitry 1104A may access a communication protocol stack 1136 in the memory/storage 1113 to communicate over a 3GPP compatible network. In general, the baseband processor circuitry 1104A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1108.

The baseband processor circuitry 1104A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1113 may include any type of volatile or non-volatile memory that may be distributed throughout the user device 1100. In some embodiments, some of the memory/storage 1113 may be located on the processors 1104 themselves (for example, L1 and L2 cache), while other memory/storage 1113 is external to the processors 1104 but accessible thereto via a memory interface. The memory/storage 1113 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1108 may include transceiver circuitry and a radio frequency front module (RFEM) that allows the user device 1100 to communicate with other devices over a radio access network. The RF interface circuitry 1108 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1124 and proceed to filter and amplify (with a low-noise amplifier) the signal. The signal may be provided to a receiver of the transceiver that down-converts the RF signal into a baseband signal that is provided to the baseband processor of the processors 1104.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1124.

In various embodiments, the RF interface circuitry 1108 may be configured to transmit/receive signals in a manner compatible with NR access technologies.

The antenna 1124 may include a number of antenna elements that each convert electrical signals into radio waves to travel through the air and to convert received radio waves into electrical signals. The antenna elements may be arranged into one or more antenna panels.

The antenna 1124 may have antenna panels that are omnidirectional, directional, or a combination thereof to enable beamforming and multiple input, multiple output communications. The antenna 1124 may include microstrip antennas, printed antennas fabricated on the surface of one or more printed circuit boards, patch antennas, phased array antennas, etc. The antenna 1124 may have one or more panels designed for specific frequency bands including bands in FR1 or FR2.

The user interface circuitry 1116 includes various input/output (I/O) devices designed to enable user interaction with the user device 1100. The user interface 1116 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the user device 1100.

The sensors 1120 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1122 may include software and hardware elements that operate to control particular devices that are embedded in the user device 1100, attached to the user device 1100, or otherwise communicatively coupled with the user device 1100. The driver circuitry 1122 may include individual drivers allowing other components to interact with or control various input/output (I/O) devices that may be present within, or connected to, the user device 1100. For example, driver circuitry 1122 may include a display driver to control and allow access to a display device, a touchscreen driver to control and allow access to a touchscreen interface, sensor drivers to obtain sensor readings of sensor circuitry 1120 and control and allow access to sensor circuitry 1120, drivers to obtain actuator positions of electro-mechanic components or control and allow access to the electro-mechanic components, a camera driver to control and allow access to an embedded image capture device, audio drivers to control and allow access to one or more audio devices.

The PMIC 1124 may manage power provided to various components of the user device 1100. In particular, with respect to the processors 1104, the PMIC 1124 may control power-source selection, voltage scaling, battery charging, or DC-to-DC conversion.

In some embodiments, the PMIC 1124 may control, or otherwise be part of, various power saving mechanisms of the user device 1100. For example, if the platform user device is in an RRC_Connected state, where it is still connected to the radio access network (RAN) node as it expects to receive traffic shortly, then it may enter a state known as Discontinuous Reception Mode (DRX) after a period of inactivity. During this state, the user device 1100 may power down for brief intervals of times and thus save power. If there is no data traffic activity for an extended period of time, then the user device 1100 may transition off to an RRC_Idle state, where it disconnects from the network and does not perform operations such as channel quality feedback, handover, etc. The user device 1100 goes into a very low power state and it performs paging where again it periodically wakes up to listen to the network and then powers down again. The user device 1100 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1128 may power the user device 1100, although in some examples the user device 1100 may be mounted deployed in a fixed location, and may have a power supply coupled to an electrical grid. The battery 1128 may be a lithium ion battery, a metal-air battery, such as a zinc-air battery, an aluminum-air battery, a lithium-air battery, and the like. In some implementations, such as in vehicle-based applications, the battery 1128 may be a typical lead-acid automotive battery.

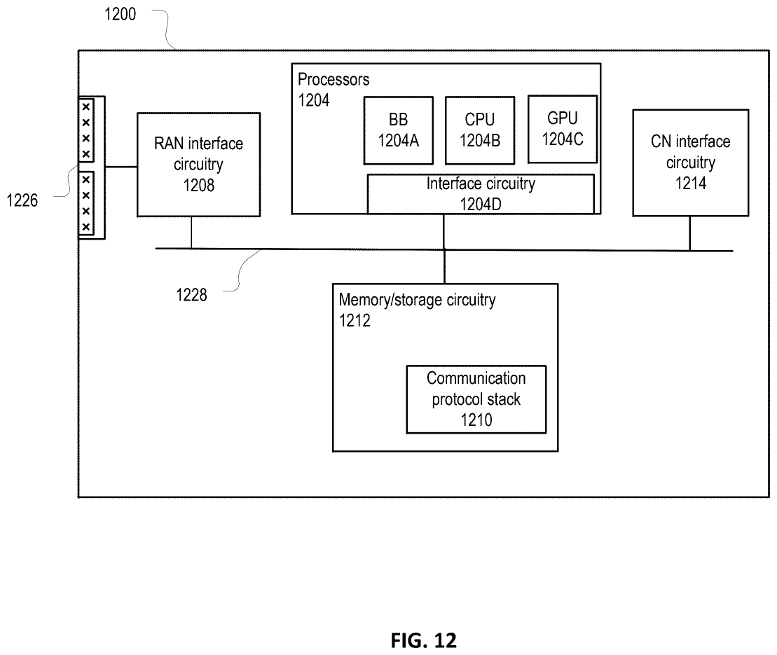

FIG. 12 illustrates a network node 1200, in accordance with some embodiments. The network node 1200 may include processors 1204, RF interface circuitry 1208, core network (CN) interface circuitry 1213, and memory/storage circuitry 1216. The network node 1200 can be a node of a RAN or a CN.

The components of the network node 1200 may be coupled with various other components over one or more interconnects 1228.

The processors 1204, RF interface circuitry 1208, memory/storage circuitry 1216 (including communication protocol stack 1210), antenna 1224, and interconnects 1228 may be similar to like-named elements shown and described with respect to FIG. 10.

The CN interface circuitry 1213 may provide connectivity to a CN, for example, a 4th Generation Core network (5GC) using a 4GC-compatible network interface protocol such as carrier Ethernet protocols, or some other suitable protocol. Network connectivity may be provided to/from the network node 1200 via a fiber optic or wireless backhaul. The CN interface circuitry 1213 may include one or more dedicated processors or FPGAs to communicate using one or more of the aforementioned protocols. In some implementations, the CN interface circuitry 1213 may include multiple controllers to provide connectivity to other networks using the same or different protocols.

As indicated above, in other embodiments, the network node 1200 can be a CN node. In these embodiments, the network node 1200 include RF interface circuitry 1208 for connectivity with a RAN. The RF interface circuitry 1208 may include one or more dedicated processors or FPGAs to communicate using one or more of the aforementioned protocols. In some implementations, the RF interface circuitry 1208 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a user device base station, network element, etc. as described above in connection with one or more of the preceding figures may be configured to operate in accordance with one or more of the examples set forth below in the example section.

### EXAMPLES

In the following sections, further example embodiments are provided.

Example 1 can include a method performed by an apparatus in a first device, the method comprising: processing a request for a position of the first device, the first device in operable connection with a second device and executing an application that generates the request; determining first position information indicating the position of the first device; causing the second device to generate second position information indicating a position of the second device; processing the second position information received from the second device; selecting between using the first position information and the second position information as indicating the position of the first device; and providing the selected position information to the application.

Example 2 can include the method of example 1, wherein the first device is experiencing worse radio frequency (RF) conditions than the second device, and wherein the second device determines the second position information prior to the first device determining the first position information based on the worse RF conditions.

Example 3 can include the method of any of examples 1 or 2, wherein causing the second device to generate second position information indicating a position of the second device comprises transmitting a message to second device over a direct data connection.

Example 4 can include the method of any of examples 1-3, wherein processing the second position information received from the second device comprises: determining that the first device and the second device being within a threshold wireless distance of each other, wherein the second position information is processed based on the first device and the second device being within a threshold wireless distance of each other.

Example 5 can include the method of any of examples 1-4, wherein the first device determines the first position information in parallel with the second device determining the second position information.

Example 6 can include the method of any of examples 1-5, wherein selecting between using the first position information and the second position information as indicating the position of the first device comprises: determining that the first device determined the first position information prior to processing the second position information from the second device; and determining to transmit the first position information to the application based on the first device determining the first position information prior to processing the second position information from the second device.

Example 7 can include the method of any of examples 1-5, wherein selecting between using the first position information and the second position information as indicating the position of the first device comprises: determining that the first device determined the first position information after processing the second position information from the second device; comparing a first accuracy of the first position information to a second accuracy of the second position information; and determining to use the first position information or the second position information based on the comparison.

Example 8 can include the method of example 7, wherein comparing the first accuracy of the first position information to the second accuracy of the second position information comprises; determining a first signal strength of a first signal used to determine the first position information; determining a second signal strength of a second signal used to determine the second position information; and comparing the first signal strength to the second signal strength, wherein the determination to use the first position information or the second position information is based on the comparison of the first signal strength to the second signal strength.

Example 9 can include the method of any of examples 1-8, wherein the second position information is received from the second device via a server.

Example 10 can include the method of any of examples 1-8, wherein the second position information is received directly from the second device over a direct data connection.

Example 11 can include the method of any of examples 1-10, wherein the method further comprises: updating the second position information to indicate that the position of the second device is the position of the first device.

Example 12 can include the method of any of examples 1-11, wherein providing the selected position information to the application comprises: generating a message indicating the position of the second device as the position of the first device.

Example 13 can include the method of any of examples 1-12, wherein the second position information comprises almanac information and ephemeris information, and wherein the method further comprises: determining a second position of the first device based on the almanac information and the ephemeris information.

Example 14 can include the method of any of examples 1-13, wherein the method further comprises: detecting that the first device is connected to the second device via a network connection, wherein the selected position information is provided to the application based on the network connection.

Example 15 can include the method of any of examples 1-14, wherein the method further comprises: detecting that the first device is associated with a same account as the second device, wherein the selected position information is provided to the application based on the association.

Example 16 can include an apparatus associated with a first device and comprising: processing circuitry to perform any of the steps of examples 1-15; and memory coupled to the processing circuitry, the memory to store the position information.

Example 17 can include one or more non-transitory, computer-readable media having stored thereon a sequence of instructions which, when executed by one or more processors, cause processing circuitry of a first device to perform any of the steps of examples 1-15.

Example 18 can include an apparatus associated with a first device and comprising: processing circuitry to: process a first message from a second device, the first message triggering a position determination process, determine whether the second device is associated with a same account as the first device, execute the position determination process based on the second device being associated with the first device, an output of the position determination process including position information of the first device, and cause a second message comprising the position information to be transmitted to second device, wherein the second message causes the second device to use the position information as indicating a position of the second device; and memory coupled to the processing circuitry, the memory to store the position information.

Example 19 can include the apparatus of example 18, wherein the processing circuitry further to: generate the second message to indicate that the position information is associated with the first device.

Example 20 can include the apparatus of any of examples 18 or 19, wherein the processing circuitry further to: generate the second message to indicate a position of the second device and a signal strength of a satellite signal used to determine the position of the second device.

Example 21 can include a method for performing any of the steps of examples 18-20.

Example 22 can include one or more non-transitory, computer-readable media having stored thereon a sequence of instructions which, when executed by one or more processors, cause processing circuitry of a first device to perform any of the steps of examples 18-20.

Example 23 can include one or more non-transitory, computer-readable media having stored thereon a sequence of instructions which, when executed by one or more processors, cause processing circuitry of a first device to: process a request for a position of the first device, the first device executing an application that generates the request; determine first position information indicating the position of the first device; determine that the first device is connected to a second device via a first data connection; cause the second device to generate second position information indicating a position of the second device based on determining that the first device is connected to the second device via the first data connection; process the second position information received from the second device over the first data connection; select between using the first position information and the second position information as indicating the position of the first device; and provide the selected position information to the application.

Example 24 can include the one or more non-transitory, computer-readable media of example 22, wherein selecting between using the first position information and the second position information as indicating the position of the first device is based on a signal strength of a satellite signal used to determine the second position information.

Example 25 can include a method for performing any of the steps of examples 23 or 24.

Example 26 can include an apparatus associated with a first device and comprising: processing circuitry to perform any of the steps of examples 23 or 24; and memory coupled to the processing circuitry, the memory to store the position information.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method performed by an apparatus in a first device, the method comprising:
processing a request for a position of the first device, the first device in operable connection with a second device and executing an application that generates the request;
determining first position information indicating the position of the first device;
causing the second device to generate second position information indicating a position of the second device;
processing the second position information received from the second device;
selecting between using the first position information and the second position information as indicating the position of the first device; and
providing the selected first position information to the application.

2. The method of claim 1, wherein the first device is experiencing worse radio frequency (RF) conditions than the second device, and wherein the second device determines the second position information prior to the first device determining the first position information based on the worse RF conditions.

3. The method of claim 1, wherein causing the second device to generate second position information indicating a position of the second device comprises transmitting a message to second device over a direct data connection.

4. The method of claim 1, wherein processing the second position information received from the second device comprises:
determining that the first device and the second device being within a threshold wireless distance of each other, wherein the second position information is processed based on the first device and the second device being within a threshold wireless distance of each other.

5. The method of claim 1, wherein the first device determines the first position information in parallel with the second device determining the second position information.

6. The method of claim 1, wherein selecting between using the first position information and the second position information as indicating the position of the first device comprises:
determining that the first device determined the first position information prior to processing the second position information from the second device; and
determining to transmit the first position information to the application based on the first device determining the first position information prior to processing the second position information from the second device.

7. The method of claim 1, wherein selecting between using the first position information and the second position information as indicating the position of the first device comprises:
determining that the first device determined the first position information after processing the second position information from the second device;
comparing a first accuracy of the first position information to a second accuracy of the second position information; and
determining to use the first position information or the second position information based on the comparison.

8. The method of claim 7, wherein comparing the first accuracy of the first position information to the second accuracy of the second position information comprises;
determining a first signal strength of a first signal used to determine the first position information;
determining a second signal strength of a second signal used to determine the second position information; and
comparing the first signal strength to the second signal strength, wherein the determination to use the first position information or the second position information is based on the comparison of the first signal strength to the second signal strength.

9. The method of claim 1, wherein the second position information is received from the second device via a server.

10. The method of claim 1, wherein the second position information is received directly from the second device over a direct data connection.

11. The method of claim 1, wherein the method further comprises:
updating the second position information to indicate that the position of the second device is the position of the first device.

12. The method of claim 1, wherein providing the selected first position information to the application comprises:
generating a message indicating the position of the second device as the position of the first device.

13. The method of claim 1, wherein the second position information comprises almanac information and ephemeris information, and wherein the method further comprises:
determining a second position of the first device based on the almanac information and the ephemeris information.

14. The method of claim 1, wherein the method further comprises:
detecting that the first device is connected to the second device via a network connection, wherein the selected first position information is provided to the application based on the network connection.

15. The method of claim 1, wherein the method further comprises:
detecting that the first device is associated with a same account as the second device, wherein the selected first position information is provided to the application based on the association.

16. An apparatus associated with a first device and comprising:
processing circuitry to:
process a first message from a second device, the first message triggering a position determination process,
determine whether the second device is associated with a same account as the first device,
execute the position determination process based on the second device being associated with the first device, an output of the position determination process including position information of the first device, and
cause a second message comprising the position information to be transmitted to second device, wherein the second message causes the second device to use the position information as indicating a position of the second device; and
memory coupled to the processing circuitry, the memory to store the position information.

17. The apparatus of claim 16, wherein the processing circuitry further to:
generate the second message to indicate that the position information is associated with the first device.

18. The apparatus of claim 16, wherein the processing circuitry further to:
generate the second message to indicate a position of the second device and a signal strength of a satellite signal used to determine the position of the second device.

19. One or more non-transitory, computer-readable media having stored thereon a sequence of instructions which, when executed by one or more processors, cause processing circuitry of a first device to:
process a request for a position of the first device, the first device executing an application that generates the request;
determine first position information indicating the position of the first device;
determine that the first device is connected to a second device via a first data connection;
cause the second device to generate second position information indicating a position of the second device based on determining that the first device is connected to the second device via the first data connection;
process the second position information received from the second device over the first data connection;
select between using the first position information and the second position information as indicating the position of the first device; and
provide the selected first position information to the application.

20. The one or more non-transitory, computer-readable media of claim 19, wherein selecting between using the first position information and the second position information as indicating the position of the first device is based on a signal strength of a satellite signal used to determine the second position information.
